(19) United States
(12) Patent Application Publication
(10) Pub. No.: US 2003/0188878 A1
(43) Pub. Date: Oct. 9, 2003

(54) Percussion tool

(76) Inventor: Adrian J. Paulhus, Radville (CA)

Correspondence Address: W. Thad Adams, III, Adams, Schwartz & Evans, P.A., 2180 Two Wachovia Center, Charlotte, NC, 28282, US

(21) Appl. No.: 10/116,382

(22) Filed: Apr. 4, 2002

(51) Int. Cl. B25D 15/00

(52) U.S. Cl. 173/205

(57) ABSTRACT

An apparatus for providing repetitive percussive blows in tools and the like comprises an elongated hammer movable along its longitudinal axis from an extended position to a retracted position. A bias element urges the hammer towards the extended position. A cam member is attached to a face of a rotating drive member at a point removed from the drive member's rotational axis. The cam member bears against the hammer during only a portion of each revolution of the drive member so as to move the hammer against the bias force from the extended position to the retracted position and then release the hammer, which then moves toward the extended position to deliver a percussive blow.

This invention is in the field of powered tools and in particular such tools that provide repetitive percussive blows.

### BACKGROUND

Tools such as jack-hammers, power nailers, power staplers and the like require an apparatus that provides repetitive percussive blows of varying stroke and force to accomplish the purpose of the tool. Such percussion tools are most often driven by compressed air which is often not readily available, or at least not easily portable.

Electric powered solenoids have been used however these are relatively weak. Electric motor driven tools are known as well. U.S. Pat. No. 3,587,754 to Laatsch provides a percussion element which is repetitively moved against a biassing force and then released to provide a percussive blow. This movement and release is accomplished by a gear with teeth on only one half of its circumference. The device is subject to wear as this gear must repeatedly engage and disengage the teeth of a drive gear.

Similarly U.S. Pat. No. 5,511,715 to Crutcher et al. provides a complex mechanism including cables and clutches for repetitively moving an element against a biassing force and then releasing same to provide a percussive blow.

### SUMMARY OF THE INVENTION

It is an object of the present invention to provide an improved apparatus for providing repetitive percussive blows in tools and the like. The apparatus comprises an elongated hammer movable along its longitudinal axis from an extended position to a retracted position. A bias element urges the hammer towards the extended position. A cam member is attached to a face of a rotating drive member at a point removed from the drive member's rotational axis. The cam member bears against the hammer during only a portion of each revolution of the drive member so as to move the hammer against the bias force from the extended position to the retracted position and then release the hammer, which then moves toward the extended position to deliver a percussive blow.

The invention provides a simple apparatus with reduced maintenance requirements compared to prior art devices.

### DESCRIPTION OF THE DRAWINGS

While the invention is claimed in the concluding portions hereof, preferred embodiments are provided in the accompanying detailed description which may be best understood in conjunction with the accompanying diagrams where like parts in each of the several diagrams are labeled with like numbers, and where:

FIG. 1 is a front view of an apparatus of the invention, with a front housing cover plate removed;

FIG. 2 is a side view of the apparatus of FIG. 1, with a side housing cover plate removed;

FIGS. 3-3E are schematic front views of the apparatus of FIG. 1 showing the action of the parts of the apparatus as the drive disc moves through one revolution;

FIG. 4 shows an alternate orientation of the parts of the apparatus;

FIGS. 5 and 5A show another alternate orientation of the parts of the apparatus, and the stroke achieved;

FIG. 6 shows the drive disc rotating in the opposite direction in an another alternate orientation of the parts of the apparatus, and the stroke achieved;

FIGS. 7, 7A and 7B are top, front and side views of another alternate apparatus where the cam roller rotates in a plane that passes through the hammer;

FIGS. 8 and 8A are front and side views of an alternate drive member being a crank;

FIG. 9 shows an apparatus incorporated into a power nailer.

### DETAILED DESCRIPTION OF THE ILLUSTRATED EMBODIMENTS

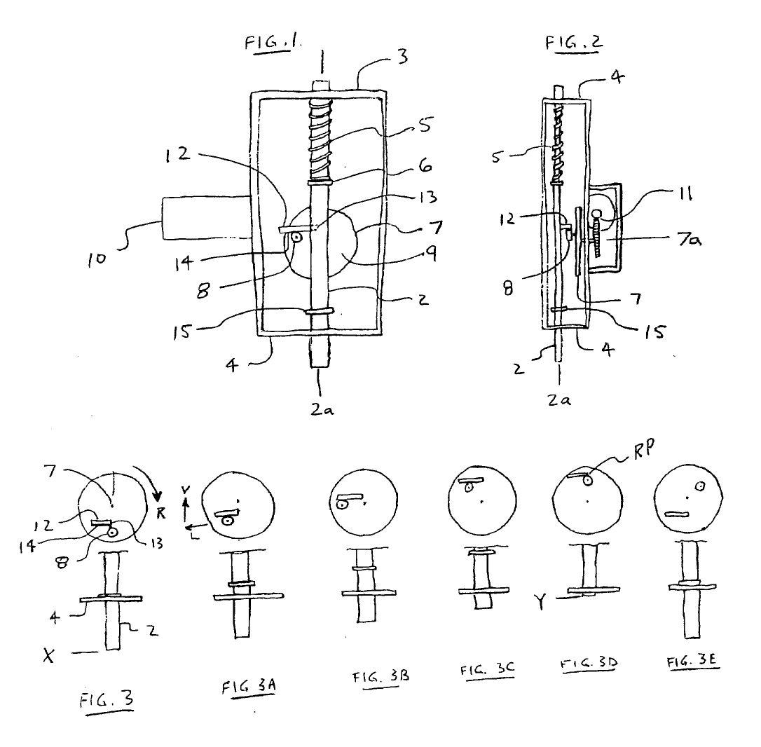

FIGS. 1 and 2 illustrate an apparatus for providing repetitive percussive blows. The apparatus is supported in a housing 1 and comprises an elongated hammer 2 having a longitudinal axis 2a. The hammer 2 is movable along the longitudinal axis 2a from an extended position X to a retracted position Y, as schematically illustrated in FIGS. 3 and 3D. FIG. 1 shows the hammer 2 in an intermediate position. The hammer 2 is guided by passing through guide apertures in the top and bottom plates 3, 4 of the housing 1.

In the illustrated embodiment, the bias element is a compression spring 5 which slides over the hammer 2 and pushes against the spring ridge 6 on the hammer 2 and against the top plate 3 so as to exert a bias force urging the hammer 2 towards the extended position X. The bias element alternatively could be a different arrangement of compression or expansion springs, a fluid cylinder or other conventional means.

The drive member for the apparatus is a drive disc 7 rotatably mounted in the housing 1 about a rotational axis 7a that is substantially perpendicular to the longitudinal axis 2a of the hammer 2. The disc shape is convenient for the purpose, but could be rectangular or any other shape. A cam roller 8 is annular in form and is rotatably attached, about a cam axis 8a that is substantially parallel to the rotational axis 7a, to the face 9 of drive disc 7 at a point removed from the rotational axis 7a. The distance from the cam roller 8 to the rotational axis 7a influences the stroke of the hammer 2. A shorter stroke when the distance is small, increasing as the distance increases. The stroke also varies with the location of the hammer 2 with respect to the rotational axis 7a, as will be more clearly set out later.

The cam roller 8 bears against the hammer 2 during only a portion of each revolution of the drive disc 7 so as to move the hammer 2 against the bias force exerted by spring 5 from the extended position X to the retracted position Y and release the hammer 2. FIGS. 3-3E illustrate the action of the apparatus as the drive disc 7 rotates through a full revolution.

The illustrated drive comprises an electric motor 10 and worm gear assembly 11 operational to rotate the drive disc 7. The worm gear assembly 11 provides a convenient speed reduction so that the speed of the hammer blows can be reduced below the speed of the electric motor 10. Other conventional drives that rotated the drive disc 7 would suffice as well.

The cam roller 8 bears against a flange 12 extending from the hammer 2 generally perpendicular to the longitudinal axis 2a and perpendicular to the rotational axis 7a. The flange 12 includes a trailing edge 13 generally parallel to the rotational axis 7a. In the illustrated embodiment the trailing edge 13 intersects the longitudinal axis 2a. The rotational axis 7a also intersects the longitudinal axis 2a. Thus the trailing edge 13 moves up and down in line with the center of the drive disc and the center of the hammer 2. This orientation provides the maximum stroke and provides for a minimum of torque on the hammer 2, as the release point RP, as illustrated in FIG. 3D is aligned with the longitudinal axis 2a of the hammer 2.

As can best be seen in FIG. 2, the cam roller 8 rotates in a plane that lies between the face 9 of the drive disc 7 and the hammer 2. The cam roller 8 contacts only the flange 8, and passes freely between the face 9 of the drive disc 7 and the hammer 2 as the drive disc 7 rotates.

The cam roller 8 could alternatively be a non rotating cam member. The rotational mounting and annular form reduce friction and wear between the flange 12 and the cam member, as the roller rolls along the bearing face 14 of the flange 12, rather than sliding.

The operation of the apparatus is best seen in the schematic illustrations of FIGS. 3-3E. In FIG. 3, the stop ridge 15 on the hammer 2 is resting against the bottom plate 4 of the housing 1, and the cam roller 8 is just rotating into position below the bearing face 14 of the flange 12. The drive disc 7 is rotating in the direction R as indicated by the arrow. At this point in the revolution and with this orientation, the lateral component L of the movement of the cam roller 8 is predominant and the vertical component V is minimal as the cam roller 8 contacts the flange 12, resulting in relatively minor shock during the contact. The cam roller 8 and hammer 2 then accelerate as the vertical component increases with further rotation of the disc 7.

FIGS. 3A-3C show the cam roller 8 moving the flange 12, and thus the hammer 2, upwards. FIG. 3D shows the hammer at the release point RP, where the cam roller 8 is about to move off the trailing edge 13 of the flange 12. As soon as the cam roller 8 moves past the release point RP, the hammer 2 responds to the bias force of the spring 5 and drives down to deliver a percussive blow. If there is nothing to receive the blow, the hammer drives out to the extended position X and is stopped by the stop ridge 15 striking against the bottom plate 4.

Other orientations of the hammer 2, drive disc 7 with rotation direction R indicated by the arrow, cam roller 8 and flange 12 are illustrated in FIGS. 4 to 7B. In FIG. 4 the trailing edge 13 of the flange 12 is aligned with the rotational axis 7a, however the longitudinal axis 2a of the hammer 2 is located to the side. The length of the stroke is S1.

FIGS. 5, 5A longitudinal axis 2a of the hammer 2 is aligned with the rotational axis 7a, however the trailing edge 13 of the flange 12 is located to the side. With the trailing edge 13 removed from the rotational axis 7a, the length of the stroke is reduced to S2.

In FIG. 6, the drive disc 7 is rotating in the opposite direction and both the longitudinal axis 2a of the hammer 2 and the trailing edge 13 of the flange 12 are located to the side of the rotational axis 7a. The length of the stroke is again reduced from S1 to S3.

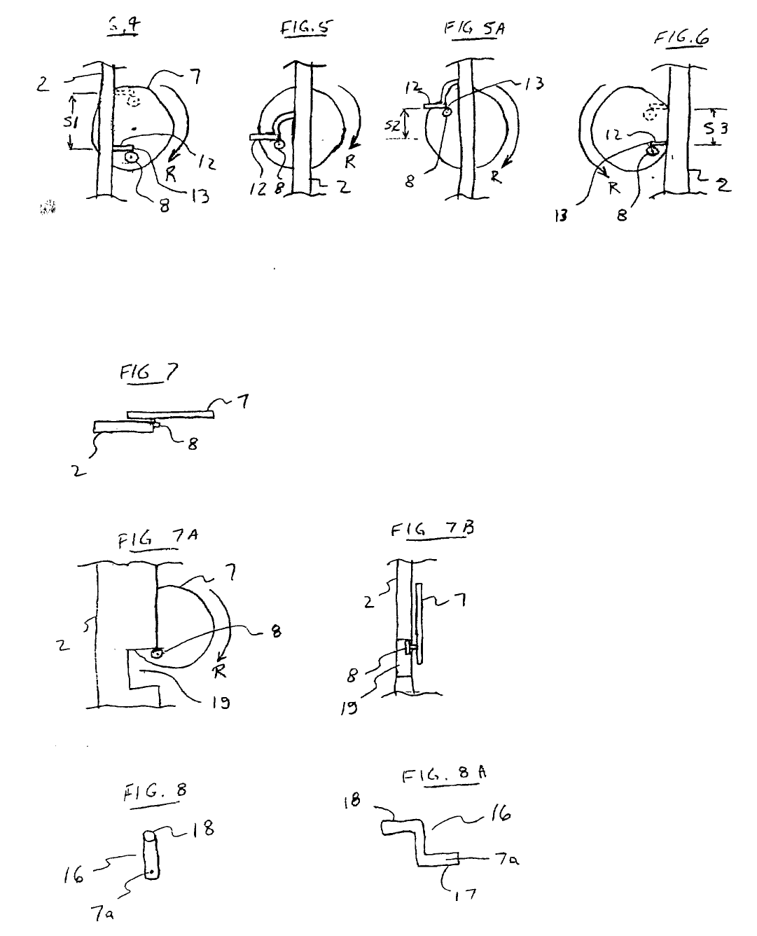

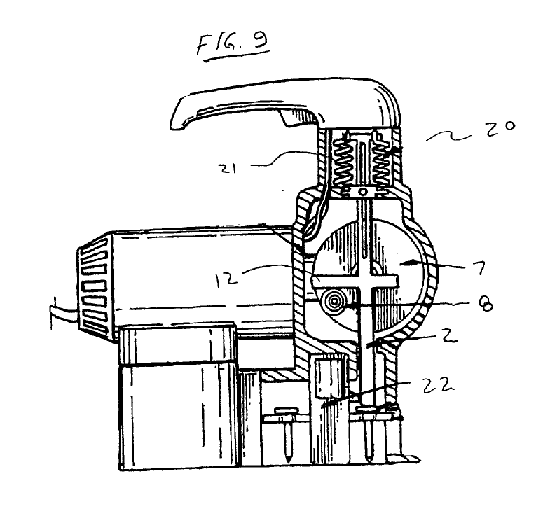

FIGS. 7, 7A and 7B illustrate an apparatus where the cam roller 8 rotates in a plane that passes through the hammer 2, and where the cam roller 8 bears against a notch 19 in the hammer 2. The top of the notch 19 then acts as a flange against which the cam roller 8 bears.

FIGS. 8 and 8A illustrate an alternate drive member being a crank 16 having a drive end 17 rotatable about the rotational axis 7a, and a cam end 18 for bearing against the flange 12 to move the hammer 2.

FIG. 9 illustrates a power nailer 20 incorporating the apparatus of the invention. The nailer 20 uses expansion springs 21 to bias the hammer 2. A nail feed mechanism 22 delivers nails to a position below the hammer 2 to receive a percussive blow from the hammer 2. Other percussion tools such as jack-hammers could similarly incorporate the apparatus. It is also contemplated that the apparatus could be useful in other applications where repetitive percussive blows are required.

The foregoing is considered as illustrative only of the principles of the invention. Further, since numerous changes and modifications will readily occur to those skilled in the art, it is not desired to limit the invention to the exact construction and operation shown and described, and accordingly, all such suitable changes or modifications in structure or operation which may be resorted to are intended to fall within the scope of the claimed invention.

I claim:

1. An apparatus for providing repetitive percussive blows, said apparatus supported in a housing and comprising:
an elongated hammer having a longitudinal axis and movable along said longitudinal axis from an extended position to a retracted position;
a bias element exerting a bias force urging said hammer towards said extended position;
a drive member rotatable about a rotational axis that is substantially perpendicular to said longitudinal axis of said hammer;
a cam member attached to a face of said drive member at a point removed from said rotational axis and arranged to bear against said hammer during only a portion of each revolution of said drive member so as to move said hammer against said bias force from said extended position to said retracted position and release said hammer; and
a drive operational to rotate said drive member.

2. The apparatus of claim 1 further comprising a flange extending from said hammer generally perpendicular to said longitudinal axis and perpendicular to said rotational axis, wherein said flange includes a trailing edge generally parallel to said rotational axis, and wherein said cam member bears against said flange.

3. The apparatus of claim 2 wherein said trailing edge intersects said longitudinal axis.

4. The apparatus of claim 3 wherein said rotational axis intersects said longitudinal axis.

5. The apparatus of claim 1 wherein said cam member rotates in a plane that lies between said face of the drive member and said hammer.

6. The apparatus of claim 1 wherein said cam member rotates in a plane that passes through said hammer.

7. The apparatus of claim 6 wherein said hammer defines a notch and wherein said cam member bears against said hammer by bearing against said notch.

8. The apparatus of claim 1 wherein said cam member has an annular form and is rotatably attached to said face of said drive member about a cam axis that is substantially parallel to said rotational axis.

9. The apparatus of claim 1 wherein said bias element is a spring.

10. The apparatus of claim 1 wherein said drive includes an electric motor and a worm gear mechanism.

11. A percussion tool comprising:
a housing;
an elongated hammer having a longitudinal axis and movable within said housing along said longitudinal axis from an extended position to a retracted position;
a bias element exerting a bias force urging said hammer towards said extended position;
a drive member rotatably mounted in said housing about a rotational axis that is substantially perpendicular to said longitudinal axis of said hammer;
a cam member attached to a face of said drive member at a point removed from said rotational axis;
a flange attached to said hammer and arranged such that said cam member bears against said flange during only a portion of each revolution of said drive member so as to move said hammer against said bias force from said extended position to said retracted position and release said hammer; and
a drive operational to rotate said drive member.

12. The tool of claim 11 wherein said flange extends from said hammer generally perpendicular to said longitudinal axis and perpendicular to said rotational axis, and wherein said flange includes a trailing edge generally parallel to said rotational axis.

13. The tool of claim 11 wherein said cam member rotates in a plane that lies between said face of the drive member and said hammer.

14. The tool of claim 11 wherein said cam member rotates in a plane that passes through said hammer.

15. The tool of claim 11 wherein said cam member has an annular form and is rotatably attached to said face of the drive member about a cam axis that is substantially parallel to said rotational axis.

16. The tool of claim 11 wherein said bias element is a spring.

17. The tool of claim 11 wherein said drive includes an electric motor and a worm gear mechanism.

18. The tool of claim 11 wherein said tool is a power nailer.
